(19) United States
(12) Patent Application Publication
(10) Pub. No.: US 2025/0340446 A1
(43) Pub. Date: Nov. 6, 2025

(54) Pond System for Effective Sodium Carbonate Separation from Sodium Chloride

(71) Applicant: Genesis Alkali Wyoming, LP, Philadelphia, PA (US)

(72) Inventors: Aaron P. Reichl, Green River, WY (US); Aileen M. Halverson, Green River, WY (US); Kevin L. Green, Green River, WY (US)

(21) Appl. No.: 19/188,852

(22) Filed: Apr. 24, 2025

Related U.S. Application Data
(60) Provisional application No. 63/642,134, filed on May 3, 2024.

(51) Int. Cl. C01D 7/24; C01D 3/08; C01D 3/14

(52) U.S. Cl. CPC C01D 7/24; C01D 3/08; C01D 3/14

(57) ABSTRACT

A multi-pond system and method is disclosed for separating sodium carbonate from sodium chloride in process purge streams from soda ash production or similar facilities. The system comprises a first pond, exposed to atmospheric environment, for receiving the process purge stream and allowing deposition of sodium carbonate in accord with phase chemistry as water is evaporated and temperatures change thereby creating a liquor with increased sodium chloride concentration. A second pond for receiving the first pond liquor, exposed to the atmospheric environment, and allowing deposition of sodium chloride in accord with phase chemistry as water evaporates and temperatures change thereby creating a second pond liquor with increased sodium carbonate concentration. Alternatively transferring at least a portion of the second pond liquor back to the first pond or into an optional third pond.

### CROSS-REFERENCE TO RELATED APPLICATIONS

This application claims priority to U.S. Provisional Application No. 63/642,134 (“the '134 Application”) filed May 3, 2024. The '134 Application is hereby incorporated by reference in its entirety for all purposes, including but not limited to, all portions describing the separation system of the present invention and the embodiments disclosed, those portions describing background and for use with specific embodiments of the present invention, and those portions describing other aspects of the method and systems that may relate to the present invention.

### STATEMENTS REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

### 1. Field of the Invention

The present invention relates to a method and a system for separating sodium carbonate from sodium chloride in the purge streams of soda ash or similar production facilities. More particularly, the present invention relates to a method and a system for utilizing phase chemistry across a series of ponds to separate sodium carbonate from sodium chloride in the purge streams of soda ash or similar production facilities.

### 2. Description of the Related Art

As solution mining becomes more prevalent in natural soda ash production, the ratio of sodium chloride (salt) to sodium carbonate/bicarbonate in soda ash plant feedstocks is likely to increase for several reasons. First is that solution mining is typically less selective than dry mining. Solution mining will dissolve whatever water-soluble mineral it contacts and sodium chloride dissolves faster than trona, the sodium carbonate containing mineral. Dry mining can, to some extent, avoid soluble mineral lenses that are on the top or bottom of the target mineral bed. Second, is that dry mining has targeted the shallowest and most consistent beds of mineral. Solution mining often targets the thickest bed and/or the beds with the least amount of mineralization in between them. These target beds for solution mining often have additional salt in or near the beds, relative to soda ash content compared to the currently dry mined areas.

Soda ash specifications typically limit sodium chloride content to ˜0.1% in soda ash that is at least 99% pure. Thus, any deposit that has a salt to soda ash equivalent ratio greater than 1 to 990, must result in a purge stream from the process. These purge streams are often processed through a deca or bicarbonate crystallization to recover additional soda ash values and to concentrate the salt (and other soluble impurities). After passing through the alkali recovery crystallization, the resulting ‘mother liquor’ if often purged to a pond. The purge is typically >1% NaCl up to 20% NaCl and from 3% to 28% sodium carbonate equivalent.

In the pond system, as water evaporates and/or the pond goes through seasonal cooling cycles, sodium carbonate decahydrate (deca) and/or other sodium carbonate species (sodium carbonate heptahydrate, sodium carbonate monohydrate, sodium bicarbonate, sodium sesquicarbonate) can deposit in the pond. This deca can often be harvested and then recycled back to the soda ash plant. Any deca that is not harvested, and other soluble impurities build up over time in the pond, reducing the volume available for future purge. Because ponds are expensive to build and the additional surface disturbance is not desirable for several reasons, maximizing the recovery of sodium carbonate species is important to leave the available space for sodium chloride and other soluble impurities.

As sodium chloride content increases in the pond system over the years, it will begin to precipitate along with sodium carbonate species in the pond. The inclusion of sodium chloride in the sodium carbonate species (let's focus on deca for now) makes the recovery and processing of the deca more challenging. If the ratio of salt to deca gets too high in the pond solids, those solids can no longer be recycled to the plant for cost effective processing.

As can now be seen, there is a need for a system to allow for the concentration and precipitation of nearly deca (sodium carbonate) free sodium chloride in one part of a pond system and separating that from deca (sodium carbonate species) areas so that relatively pure deca can continue to be recovered for reprocessing, leaving maximum space for sodium chloride and other soluble impurity storage/precipitation in the pond system.

### BRIEF SUMMARY OF THE INVENTION

The present invention utilizes the phase chemistry of salt versus sodium carbonate species along with use of temperature differences and evaporation differences during different seasons in a pond management system that allows for optimal separation of sodium carbonate and salt in the pond system—where the maximum sodium carbonate can be harvested, and the minimum space utilized in the pond system for carbonate species and thus available for salt species. The basic concept is that a first pond is managed for pure deca (sodium carbonated decahydrate) deposition, with most deca being deposited due to cooling. Some deca can deposit in the warmer months due to evaporation, but this will be generally limited by the amount of incoming sodium chloride. A second pond is managed for salt deposition during the evaporation season. By moving liquids between the ponds during different times of the year, nearly pure deca is deposited in the first pond and nearly pure salt is deposited in the second pond. Additional ponds can be used to assist in the management of the two primary ponds, or as final storage location for soluble impurities.

Additional advantages of the invention are set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

A better understanding of the present invention can be obtained when the following detailed description of the disclosed embodiments is considered in conjunction with the following drawings in which:

FIG. 1 is a phase diagram for a system of Na₂CO₃—NaCl in weight percentage for temperatures 0° to 60° C. with points A through F outlining various point utilized in the method; and

FIG. 2 is a block flow diagram of an embodiment of a pond system for effective separation of sodium carbonate from sodium chloride.

### DETAILED DESCRIPTION OF THE INVENTION

A multi-pond system and method is disclosed for separating sodium carbonate from sodium chloride in process purge streams from soda ash production or similar facilities. The system comprises a first pond, generally exposed to atmospheric environment, for receiving the process purge stream and allowing deposition of sodium carbonate in accord with phase chemistry as temperatures decrease thereby creating a first pond liquor with increased sodium chloride concentration. A second pond for receiving the first pond liquor, exposed to the atmospheric environment, and allowing deposition of sodium chloride in accord with phase chemistry as water evaporates and temperatures change thereby creating a second pond liquor with increased sodium carbonate concentration. Alternatively, at least a portion of the second pond liquor can be transferred back to the first pond or into an optional third pond. A portion of the purge stream can optionally be added along with at least a portion of the second pond liquor to the third pond, also generally exposed to the atmospheric environment, wherein sodium carbonate is deposited in accord with phase chemistry as temperatures decrease thereby creating a third pond liquor. An optional fourth pond can be utilized to receive at least a portion of the third pond liquor to manage impurities in the system.

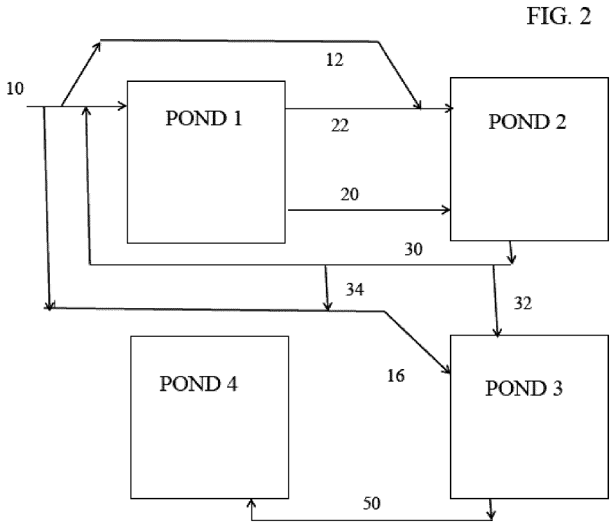

As shown in FIG. 2, in one embodiment of the system, a fresh plant purge stream 10 enters the first pond (“Pond 1”). Pond is used herein to broadly refer to outdoor liquid holding receptacles whether earthen, concrete or other construction. While a pond is referred to individually, the term pond is intended to encompass a single liquid holding receptacle or multiple holding receptacles serving as chambers with essentially the same function. Under normal operating conditions, purge stream 10 would be entering the Pond 1 continuously or near continuously; however, purge stream 10 can also be sporadic or short-term streams. Fresh plant purge stream 10 can be a purge stream from a soda ash production facility or other similar facility for which purging a liquid stream comprising sodium carbonate and sodium chloride is needed. Although in this embodiment stream 10 is a purge stream, stream 10 could include solution mined liquors, brines, process streams, naturally occurring streams, or other streams containing sodium carbonate and sodium chloride. Preferably, for purge stream 10 the sodium carbonate would be between about 1% and about 20% sodium carbonate and about 0.5% to about 22% for sodium chloride. More preferably, purge stream 10 will generally comprise between about 7% to near 12% sodium carbonate and about 3% to 7% sodium chloride in water.

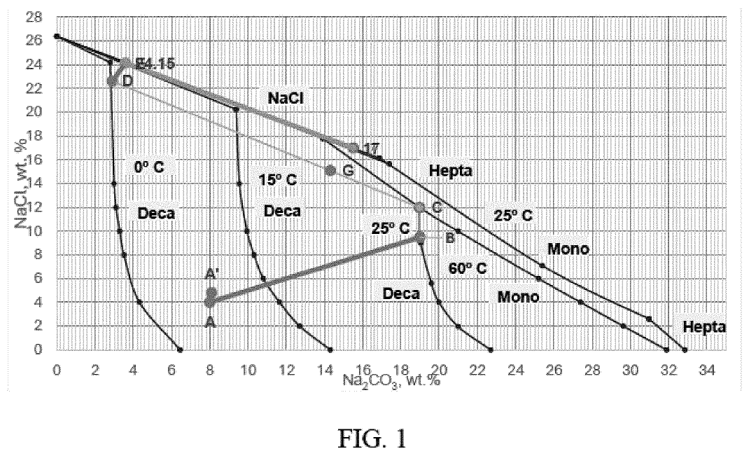

Inside Pond 1, evaporation will occur over the course of the year and by the end of the summer season, the temperature of the pond would be maximized. For the examples shown herein, a maximum temperature of the pond was assumed to be about 77° F. (25° C.), although this maximum temperature could vary widely depending on the location of the system, generally pond maximum temperatures can be between about 10° and 30° C. without significantly impacting the process. As the temperature of Pond 1 warms, sodium carbonate will reach maximum solubility. Looking to FIG. 1, in this example as the concentration gets to about 19% Na₂CO₃ (Point B), (assuming <12% NaCl), then deca will deposit in Pond 1 during the evaporation season (Segment B-C on FIG. 1). As used herein, evaporation season generally means the summer months when atmospheric temperatures are higher. The evaporation season may vary from year to year and place to place. As a person of ordinary skill in the art will recognize, the concentrations in the ponds, and therefore the operating Points A through F, vary with temperature, composition of the liquids, etc. Phase diagrams such as shown in FIG. 1 can be utilized to define desired operational parameters. Preferably, it is desirable to manage the sodium chloride content of Pond 1 to less than about 12% (Point C) to ensure no significant salt deposits in this first pond (Pond 1) during the evaporation season or the subsequent cooling season. As used herein, managing the sodium chloride content in Pond 1 means that adjustments can be made by adding additional aqueous streams that comprising less than 12% sodium chloride to keep the overall composition of Pond 1 below 12%.

As the season changes and the evaporation season ends, Pond 1 begins to cool (Segment C-D on FIG. 1) and deca deposits in Pond 1 and will continue to deposit until Pond 1 reaches the saturation level of sodium carbonate and its minimum concentration (Point D), generally about 0° C. In locations where ambient temperatures do not cool to 0° C., the process still works as proposed. However, point D would be further to the right (more concentrated in sodium carbonate) and the amount of deposited deca in Pond 1 and the amount of sodium chloride deposited in Pond 2 during each seasonal cycle would be less. An advantage of depositing deca is that the decahydrate crystal has ten water molecules and the recovery of the deca will also recover water, reducing the amount of water lost to evaporation in the pond system. This deca can be harvested and recycled back to the soda ash operation, increasing alkali efficiency, and reducing make-up water needs. As will now be recognized by a person of skill in the art, the evaporation and related deposition in Pond 1 described above (see FIG. 1, points A to B to C) will not always be necessary depending upon the stream concentrations of sodium carbonate and sodium chloride. It is the crystallization resulting from dropping the temperature (see FIG. 1, points C to D) that is most significant in the system.

At this point, the first pond liquor 20 will be reduced in sodium carbonate concentration and increased in sodium chloride concentration (due to removal of water from decahydrate crystallization). Once the deca deposition has completed and if the sodium chloride concentration is above about 20% NaCl (depending on temperature, water inflow and make-up), the first pond liquor 20 is pumped to Pond 2 (generally referred to as the salt pond) before it is diluted or warmed.

As the weather warms and evaporation begins, Pond 2 which started very low in sodium carbonate, should concentrate, and then reach sodium chloride saturation (Point E). Sodium chloride will be deposited in Pond 2. As the sodium chloride deposits and water warms and evaporates, the sodium carbonate concentration will increase. Assuming for example Pond 2 reaches its maximum temperature (assume about 77° F. for example), only relatively pure sodium chloride will be deposited in Pond 2 if the sodium carbonate concentration is kept below about 17%. Depending on other soluble impurities, the sodium carbonate concentration may preferably be maintained below about 15% Na₂CO₃ (Point F). At this point, a significant portion of the sodium chloride will have deposited in Pond 2 and the sodium chloride concentration should be about 17%. During the warmer months when evaporation is high, in order to avoid excessive deposition of sodium carbonate in Pond 2 (salt pond) the concentration should be managed, preferably between about 15% and 17%. Depending on the concentrations in Pond 1, some Pond 1 liquor 22 (or fresh plant purge feed 12 from the process) may be pumped to Pond 2 and some Pond 2 liquor 30 may be pumped to Pond 1 to try to keep Pond 2 below sodium carbonate saturation to minimize precipitation of sodium carbonate in Pond 2 and minimize deposition of chloride in Pond 1.

At the end of the evaporation season, or prior to the end of saturation season if the Pond 2 liquor carbonate concentration is approaching saturation and if Pond 1 liquor is below chloride saturation, second pond liquor 30 from Pond 2 should now be saturated with salt and close to saturation with sodium carbonate. This condition can be managed in several ways. The second pond liquor 30 can be mixed into plant purge stream 10 forming a feed to Pond 1 (or added directly to Pond 1) with concentration A′ and then the cycle can begin again. If a third pond is available, Pond 3, a portion 32 of Pond 2 liquor 30 may be ‘purged’ to Pond 3 to manage other impurities in the system. If a fourth pond is also available, Pond 4, then Pond 3 would be operated similarly to Pond 1, only the resulting sodium carbonate deposition will likely be higher in impurities. In a four pond system it would typically be desirable to mix a portion 34 of Pond 2 liquor 30 with the plant purge stream 10 to form a mixed stream 16 somewhere with composition near point G and send mixed stream 16 to Pond 3. Pond 3 can drop out good deca as it cools and then the liquid 50 from Pond 3, which should have concentration near point D at the end of the cooling period (when to pond reaches its minimum temperature), is pumped to Pond 4 for final storage. If a 4th pond does not exist, it would typically be optimal to only purge enough material from Pond 2 (or alternatively Pond 1 effluent) to Pond 3 to manage the other soluble impurities rather recycle most of the Pond 2 liquid back to Pond 1 for further sodium carbonate recovery.

The sequence defined in FIG. 1, from A to B to C to D to E to F and then mixing F (Pond 2 liquid 30) with some or all of feed 10 for recycle, can be repeated indefinitely. Depending on other soluble impurities such as naturally occurring organics, sodium bicarbonate, sodium sulfate, potassium, or other components that can reduce the solubility of carbonate and salt, the target concentrations for each pond and each step may need to be adjusted and one or more of the segments may not be required. As an example, if the fresh plant purge is higher in salt than the example here, the concentration of salt may reach near saturation before deca starts to drop out during the evaporation season and there may not be a B-C segment in the operation. As a person of skill in the art will now understand, the pond system must be managed and adjusted depending upon the concentration and composition of the initial stream, the ambient temperatures, and the concentrations and components within each pond. Additionally, a person of ordinary skill in the art will now recognize that the size of the liquid streams and the volume of solids deposition in Pond 3 and Pond 4 will be small relative to the liquid volumes and solids depositions in Pond 1 and Pond 2 since the majority of the solids will deposit in Pond 1 and Pond 2.

If one or more of the ponds is mismanaged such that a good amount of the undesirable component is deposited in the pond (salt is undesired in Pond 1 and in Pond 3 in a four pond system and sodium carbonate is undesired in Pond 2), it could be advantageous to allow a small amount of dilution or to bring in fresh plant purge 10 during conditions where it is unsaturated with respect to the undesired impurity, so that the undesired component can be dissolved out of the solids. As an example, if Pond 2 is operated in a way such that deca or hepta carbonate drop out of solution, some unsaturated fresh plant purge 12 could be brought in to dilute the system a bit. The fresh feed 12 is unsaturated with both sodium carbonate and salt, so it will dissolve the sodium carbonate (and salt) and become saturated in both. Liquor 30 could then be mixed with the rest of the fresh plant feed and be used for feed to Pond 1.

An embodiment of the operation of the system is shown in the process simulation results of Example 1 below. This is an example of a two-pond system with a purge stream having a concentration of 8% sodium carbonate and 4% sodium chloride. The points A-F coincide with the points shown in the phase diagram of FIG. 1. In the lower part of this example, Pond 2 liquor is returned and mixed with the purge stream feed to Pond 1 increasing somewhat the concentration of sodium carbonate and sodium chloride in the feed to Pond 1.

### Example 1

| | | | | B | Pond 1 | C | D | D | | F | F |
|---|---|---|---|---|---|---|---|---|---|---|---|
| | | A | [symbol] vapor- | Pond 1 | Evap | Pond 1 | Pond 1 | Pond 1 | Pond 2 | Pond 2 | Pond 2 |
| | | Feed | atio [symbol] | after Evap | Deca [symbol] | liquid | Liquid | Solid | Evaporation | liquid | solids |
| Na2CO3 | % | 8.0 | 0 | 21.13 | 37.00 | 18.99 | 3.0311552 | 37 | 0 | 15.0097 | 0 |
| NaCl | % | 4.0 | 0 | 10.57 | — | 11.99 | 22.620561 | 0 | — | 17.03 | 100.00 |
| H2O | % | 88.0 | 100.0 | 68.30 | 63.00 | 69.02 | 74.35 | 63.00 | 100 | 67.9644 | 0 |
| Na2CO3 | tons | 1,000.00 | — | 1,000.00 | 208.00 | 792.00 | 67.00 | 725 | — | 67.00 | 0 |
| NaCl | tons | 500.00 | — | 500.00 | — | 500.00 | 500.00 | 0 | 0 | 76.00 | 424 |
| H2O | tons | 11,000.00 | 7768 | 3,232.00 | 354.16 | 2,877.84 | 1,643.38 | 1,234.46 | 1340 | 303.38 | 0 |
| Total | tons | 12,500.00 | 7,768.00 | 4,732.00 | 562.16 | 4,169.84 | 2,210.38 | 1,959.46 | 1,340.00 | 446.38 | 424.00 |

[symbol]

indicates data missing or illegible when filed

### Feed Plus Pond 2 Liqu

| | | B′ | | C′ | D′ | D′ | | F′ | F′ |
|---|---|---|---|---|---|---|---|---|---|
| | | Pond 1 | Pond 1 | Pond | Pond | Pond | Pond 2 | Pond | Pond |
| | Evapo- | after | Evap | 1 | 1 | 1 | Evapo- | 2 | 2 |
| A′ | ration | Evap [symbol] | Deca [symbol] | liquid | Liquid | Solid | ration | liquid | solids |
| 8.2416871 | 0 | 20.44 | 37.00 | 18.99 | 2.9885961 | 37 | 0 | 15.01976 | 0 |
| 4.45 | 0 | 11.03 | — | 11.99 | 22.650413 | 0 | — | 17.00 | 100.00 |
| 87.309192 | 100.0 | 68.53 | 63.00 | 69.02 | 74.36 | 63.00 | 100 | 67.98419 | 0 |
| 1,067.00 | — | 1,067.00 | 155.00 | 912.00 | 76.00 | 836 | — | 76.00 | 0 |
| 576.00 | — | 576.00 | — | 576.00 | 576.00 | 0 | 0 | 86.00 | 490 |
| 11,303.38 | 7725 | 3,578.38 | 263.92 | 3,314.46 | 1,891.00 | 1,423.46 | 1547 | 344.00 | 0 |
| 12,946.38 | 7,725.00 | 5,221.38 | 418.92 | 4,802.46 | 2,543.00 | 2,259.46 | 1,547.00 | 506.00 | 490.00 |

[symbol]

indicates data missing or illegible when filed

Another embodiment of the operation of the system is shown in the process simulation results of Example 2 below. This is a similar two-pond system with the Pond 2 liquor ultimately being returned and mixed with the purge stream to feed Pond 1. In this example, the initial concentration of sodium carbonate in the purge stream is 9% and the concentration of sodium chloride is 7%.

### Example 2

| | | | | C | D | D | | E | E |
|---|---|---|---|---|---|---|---|---|---|
| | | | | Pond 1 | Pond | Pond | Pond 2 | Pond | Pond |
| | | A | Evapo- | after | 1 | 1 | Evapo- | 2 | 2 |
| | | Feed | ration | Evap | Liquid | Solid | ration | liquid | solids |
| Na2CO3 | % | 9.0 | 0 | 16.71 | 2.9950196 | 37 | 0 | 14.8077 | 0 |
| NaCl | % | 7.0 | 0 | 12.99 | 21.770652 | 0 | — | 17.68 | 100.00 |
| H2O | % | 84.0 | 100.0 | 70.30 | 75.23 | 63.00 | 100 | 67.5092 | 0 |
| Na2CO3 | tons | 1,000.00 | — | 1,000.00 | 107.00 | 893 | — | 107.00 | 0 |
| NaCl | tons | 777.78 | — | 777.78 | 777.78 | 0 | 0 | 127.78 | 650 |
| H2O | tons | 9,333.33 | 5125 | 4,208.33 | 2,687.82 | 1,520.51 | 2200 | 487.82 | 0 |
| Total | tons | 11,111.11 | 5,125.00 | 5,986.11 | 3,572.60 | 2,413.51 | 2,200.00 | 722.60 | 650.00 |

### Feed Plus Pond 2 Liqu

| | | C | D | D | | | E |
|---|---|---|---|---|---|---|---|
| | | Pond 1 after | Pond 1 | Pond 1 | | E | Pond 2 |
| | Evaporation | Evap | Liquid | Solid | Evaporation | liquid | solids |
| 9.3546328 | 0 | 16.20 | 3.012655 | 37 | 0 | 14.78253 | 0 |
| 7.65 | 0 | 13.25 | 21.651798 | 0 | — | 17.66 | 100.00 |
| 82.993028 | 100.0 | 70.55 | 75.34 | 63.00 | 100 | 67.55404 | 0 |
| 1,107.00 | — | 1,107.00 | 126.00 | 981 | — | 126.00 | 0 |
| 905.56 | — | 905.56 | 905.56 | 0 | 0 | 150.56 | 755 |
| 9,821.15 | 5000 | 4,821.15 | 3,150.80 | 1,670.35 | 2575 | 575.80 | 0 |
| 11,833.71 | 5,000.00 | 6,833.71 | 4,182.36 | 2,651.35 | 2,575.00 | 852.36 | 755.00 |

As can now be understood by a person of ordinary skill in the art, the process of the present invention is not limited to using outdoor ponds. The pond system as described above is dependent on local weather and temperature conditions without any real controls on the environment. Rather than being limited to ponds which are outdoor holding receptacles, the process of the present invention can utilize other liquid holding vessels where the environmental conditions (temperature, pressure, volume, etc.) can be controlled. For example, process vessels that are known to those skilled in the art such as evaporators and/or crystallizers could likewise be utilized to carry out the separation by controlling the temperature, pressures, flow rates, etc.

In this broader embodiment, the system and method for separating sodium carbonate from sodium chloride in soda ash production process purge streams, comprises providing a process purge stream comprising water, sodium carbonate, and sodium chloride; a first liquid holding receptacle for receiving the process purge stream, the first liquid holding receptacle capable of controlling the process temperature and allowing evaporation of water and deposition of decahydrate in the first liquid holding receptacle, thereby creating a first liquid holding receptacle liquor with increased concentration of sodium chloride; and a second liquid holding receptacle for receiving the first liquid holding receptacle liquor, the second liquid holding receptacle being capable of controlling the process temperature and allowing evaporation of water and deposition of sodium chloride in the second liquid holding receptacle, thereby creating a second liquid holding receptacle liquor with increased concentration of sodium carbonate. The deposition of decahydrate in the first liquid holding receptacle and sodium chloride in the second liquid holding receptical includes both crystallization into the receptacle floor or in a slurry that can be separated in another process such as a centrifuge. The above-described variations to the pond system can also similarly be utilized in the liquid holding receptacle process described herein.

While the terms used herein are believed to be well-understood by one of ordinary skill in the art, definitions are set forth to facilitate explanation of certain of the presently disclosed subject matter.

When referring to crystallization and/or deposition of sodium carbonate herein, a person of skill in the art should recognize that includes crystallization and/or deposition of sodium carbonate decahydrate or other forms of sodium carbonate such as sodium carbonate monohydrate, sodium carbonate heptahydrate, etc.

Following long-standing patent law convention, the terms “a”, “an”, and “the” refer to one or more when used in this application, including the claims. Thus, for example, reference to “a window” includes a plurality of such windows, and so forth.

Unless otherwise indicated, all numbers expressing quantities of elements, dimensions such as width and area, and so forth used in the specification and claims are to be understood as being modified in all instances by the term “about”. Accordingly, unless indicated to the contrary, the numerical parameters set forth in this specification and claims are approximations that can vary depending upon the desired properties sought to be obtained by the presently disclosed subject matter.

As used herein, the term “about,” when referring to a value or to an amount of a dimension, area, percentage, etc., is meant to encompass variations of in some embodiments plus or minus 20%, in some embodiments plus or minus 10%, in some embodiments plus or minus 5%, in some embodiments plus or minus 1%, in some embodiments plus or minus 0.5%, and in some embodiments plus or minus 0.1% from the specified amount, as such variations are appropriate to perform the disclosed methods or employ the disclosed compositions.

The term “comprising”, which is synonymous with “including” “containing” or “characterized by” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter. With respect to the terms “comprising”, “consisting of”, and “consisting essentially of”, where one of these three terms is used herein, the presently disclosed and claimed subject matter can include the use of either of the other two terms.

As used herein, the term “and/or” when used in the context of a listing of entities, refers to the entities being present singly or in combination. Thus, for example, the phrase “A, S, C, and/or 0” includes A, S, C, and O individually, but also includes any and all combinations and subcombinations of A, S, C, and O.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. The foregoing disclosure and description are illustrative and explanatory thereof, and various changes in the details of the illustrated apparatus and construction and method of operation may be made without departing from the spirit in scope of the invention which is described by the following claims.

We claim:

1. A system for separating sodium carbonate from sodium chloride in soda ash production process purge streams, comprising
a feed stream comprising water, sodium carbonate, and sodium chloride;
a first pond for receiving the feed stream, the first pond being exposed to atmospheric conditions and allowing cooling of first pond contents and deposition of sodium carbonate onto a floor of the first pond through crystallization, thereby creating a first pond liquor with increased concentration of sodium chloride; and
a second pond for receiving the first pond liquor, the second pond being exposed to atmospheric conditions, allowing warming of second pond contents, evaporation of water and deposition of sodium chloride onto a floor of the second pond, thereby creating a second pond liquor with increased concentration of sodium carbonate.

2. The system of claim 1 further comprising a recycle stream, the recycle stream allowing transfer of at least a portion of the second pond liquor to the first pond.

3. The system of claim 1 further comprising a third pond for receiving at least a portion of the second pond liquor, the third pond being exposed to atmospheric conditions and allowing cooling of third pond contents and deposition of sodium carbonate onto a floor of the third pond through crystallization, thereby creating a third pond liquor.

4. The system of claim 1 further comprising a third pond for receiving at least a portion of the first pond liquor or a portion of the second pond liquor, the third pond being exposed to atmospheric condition and allowing evaporation of water and deposition of solids onto a floor of the third pond.

5. A method of recovering sodium carbonate from a stream comprising:
providing a feed stream comprising water, sodium carbonate, and sodium chloride;
providing a first liquid holding receptacle and a second liquid holding receptacle;
introducing the feed stream into the first liquid holding receptacle at a first temperature;
decreasing temperature in the first liquid holding receptacle and allowing crystallization and deposition of sodium carbonate while managing the sodium chloride concentration below about 22%, thereby creating a first liquid holding receptacle liquor;
introducing the first liquid holding receptacle liquor into the second liquid holding receptacle;
evaporating water from the second liquid holding receptacle over a period of time while increasing temperature and allowing crystallization and deposition of sodium chloride while managing the sodium carbonate concentration below about 17%, thereby creating a second liquid holding receptacle liquor.

6. The method of claim 5 wherein the feed stream comprises a soda ash production facility purge stream.

7. The method of claim 5 wherein the feed stream comprises between about 1 and about 20 percent sodium carbonate and about 0.5 and about 22 percent sodium chloride.

8. The method of claim 5 wherein the feed stream comprises between about 7 and about 12 percent sodium carbonate and about 3 to about 7 percent sodium chloride.

9. The method of claim 5 wherein prior to the decreasing temperature step in the first holding receptacle, the method further comprises the step of:
increasing temperature in the first holding receptacle causing evaporation of water from the first holding receptacle while managing sodium chloride concentration below solubility limits of sodium chloride at the increased temperature.

10. The method of claim 5 wherein prior to the decreasing temperature step in the first holding receptacle, the method further comprises the step of:
increasing temperature in the first holding receptacle causing evaporation of water from the first holding receptacle while managing sodium chloride concentration below about 12%.

11. The method of claim 5 wherein the deposition of sodium carbonate creates a slurry comprising sodium carbonate.

12. The method of claim 5 wherein the sodium carbonate concentration in the second liquid receptacle is controlled between about 15 and about 17 percent.

13. The method of claim 5 wherein the sodium carbonate concentration is managed at least in part by addition of a portion of the feed stream into the second liquid receptacle.

14. The method of claim 5 wherein at least a portion of the second liquid receptacle liquor is introduced along with the feed stream into the first liquid holding receptacle.

15. The method of claim 5 wherein the first and second liquid holding receptacle are outdoor ponds.

16. The method of claim 5 further comprising the steps of:
providing a third liquid holding receptacle; and
introducing at least a portion of the second liquid holding receptacle liquor into the third liquid holding receptacle.

17. The method of claim 5 further comprising the steps of:
providing a third liquid holding receptacle;
introducing a portion of the feed stream into the third liquid holding receptacle along with at least a portion of the second liquid holding receptacle liquor;
decreasing temperature in the third liquid holding receptacle and allowing crystallization and deposition of sodium carbonate, thereby creating a third liquid holding receptacle liquor.

18. The method of claim 17 further comprising the steps of:
providing a fourth liquid holding receptacle; and
introducing at least a portion of the third liquid holding receptacle liquor into the fourth liquid holding receptacle.

19. A method of recovering sodium carbonate from a stream comprising:
providing a feed stream comprising water, sodium carbonate, and sodium chloride;
providing a first pond and a second pond;
introducing the feed stream into the first pond at a first temperature;
increasing temperature in the first pond causing evaporation of water from the first pond while managing sodium chloride concentration below solubility limits of sodium chloride at the increased temperature;
decreasing temperature in the first pond and allowing crystallization and deposition of sodium carbonate while managing the sodium chloride concentration below about 22%, thereby creating a first pond liquor;
introducing the first pond liquor into the second pond;
evaporating water from the second pond over a period of time while increasing temperature and allowing crystallization and deposition of sodium chloride while managing the sodium carbonate concentration below about 17%, thereby creating a second pond liquor; and
introducing a portion of the second pond liquor into the first pond along with the feed stream.
